(19) United States
(12) Patent Application Publication
(10) Pub. No.: US 2017/0192673 A1
(43) Pub. Date: Jul. 6, 2017

(54) INFORMATION PROCESSING APPARATUS, INFORMATION PROCESSING METHOD, AND INFORMATION PROCESSING PROGRAM

(71) Applicant: NEC Corporation, Tokyo (JP)

(72) Inventors: Masato KITADA, Tokyo (JP); Satoru ISHII, Tokyo (JP)

(73) Assignee: NEC Corporation, Tokyo (JP)

(21) Appl. No.: 15/510,656

(22) PCT Filed: Apr. 23, 2015
(86) PCT No.: PCT/JP2015/062436

§ 371 Date: Mar. 10, 2017

(30) Foreign Application Priority Data
Sep. 16, 2014 (JP) 2014-188302

(51) Int. Cl. G06F 3/0488

(52) U.S. Cl. CPC G06F 3/04886

(57) ABSTRACT

A keyboard image is displayed so as not to make it difficult to see a screen of interest. There is provided an information processing apparatus including a display unit that arranges a first display frame and a second display frame in a vertical direction on a screen, and displays a keyboard image for an editing operation while displaying information in the first display frame and the second display frame, and a display controller that arranges, if the first display frame is a frame of interest, the first display frame and the keyboard image so the first display frame and the keyboard image do not overlap each other.

### TECHNICAL FIELD

The present invention relates to an information processing apparatus, an information processing method, and an information processing program.

### BACKGROUND ART

In the above technical field, patent literature 1 discloses a technique of moving a software keyboard by a flick gesture. Patent literature 2 discloses a technique of arranging a scroll icon in a region located on the lower side of a display screen (see FIG. 8).

### CITATION LIST

### Patent Literature

Patent literature 1: International Publication No. 2012/061628

Patent literature 2: Japanese Patent Laid-Open No. 2012-018697

### SUMMARY OF THE INVENTION

### Technical Problem

In the techniques described in the above literatures, however, it is impossible to arrange a keyboard image so as not to make it difficult to see a screen of interest.

The present invention enables to provide a technique of solving the above-described problem.

### Solution to Problem

One aspect of the present invention provides an information processing apparatus comprising:

a display unit that arranges a first display frame and a second display frame in a vertical direction on a screen, and displays a keyboard image for an editing operation while displaying information in the first display frame and the second display frame; and

a display controller that arranges, if the first display frame is a frame of interest, the first display frame and the keyboard image so the first display frame and the keyboard image do not overlap each other.

Another aspect of the present invention provides an information processing method comprising:

arranging a first display frame and a second display frame in a vertical direction on a screen, and displaying a keyboard image for an editing operation while displaying information in the first display frame and the second display frame; and

arranging, if the first display frame is a frame of interest, the first display frame and the keyboard image so the first display frame and the keyboard image do not overlap each other.

Still other aspect of the present invention provides an information processing program for causing a computer to execute a method, comprising:

arranging a first display frame and a second display frame in a vertical direction on a screen, and displaying a keyboard image for an editing operation while displaying information in the first display frame and the second display frame; and

arranging, if the first display frame is a frame of interest, the first display frame and the keyboard image so the first display frame and the keyboard image do not overlap each other.

### Advantageous Effects of Invention

According to the present invention, it is possible to display a keyboard image so as not to make it difficult to see a screen of interest.

### BRIEF DESCRIPTION OF DRAWINGS

FIG. 1 is a block diagram showing the arrangement of an information processing apparatus according to the first embodiment of the present invention;

FIG. 2 is a view showing an overview of the operation of the screen exchange processing of an information processing apparatus according to the second embodiment of the present invention;

FIG. 3 is a block diagram showing the functional arrangement of the information processing apparatus according to the second embodiment of the present invention;

FIG. 4A is a view showing the structure of display frame information of the information processing apparatus according to the second embodiment of the present invention;

FIG. 4B is a table showing the structure of the keyboard image table of the information processing apparatus according to the second embodiment of the present invention;

FIG. 5 is a table showing the structure of the movement determination table of the information processing apparatus according to the second embodiment of the present invention;

FIG. 6 is a block diagram showing the hardware arrangement of the information processing apparatus according to the second embodiment of the present invention;

FIG. 7 is a flowchart illustrating the screen operation processing procedure of the information processing apparatus according to the second embodiment of the present invention;

FIG. 8 is a flowchart illustrating the display frame moving processing procedure of the information processing apparatus according to the second embodiment of the present invention;

FIG. 9 is a view showing an overview of the keyboard image display operation of an information processing apparatus according to the third embodiment of the present invention;

FIG. 10 is a view showing the structure of the keyboard image table of the information processing apparatus according to the third embodiment of the present invention;

FIG. 11 is a flowchart illustrating the keyboard image display processing procedure of the information processing apparatus according to the third embodiment of the present invention;

FIG. 12 is a view showing an overview of the operation of the screen exchange processing of an information processing apparatus according to the fourth embodiment of the present invention;

FIG. 13 is a flowchart illustrating the screen operation processing procedure of the information processing apparatus according to the fourth embodiment of the present invention;

FIG. 14 is a flowchart illustrating the display frame moving processing procedure of the information processing apparatus according to the fourth embodiment of the present invention;

FIG. 15 is a view showing an overview of the operation of the screen exchange processing of an information processing apparatus according to the fifth embodiment of the present invention;

FIG. 16 is a flowchart illustrating the display frame moving processing procedure of the information processing apparatus according to the fifth embodiment of the present invention; and

FIG. 17 is a view showing an overview of the operation of screen exchange processing when three screens are displayed in an information processing apparatus according to the sixth embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

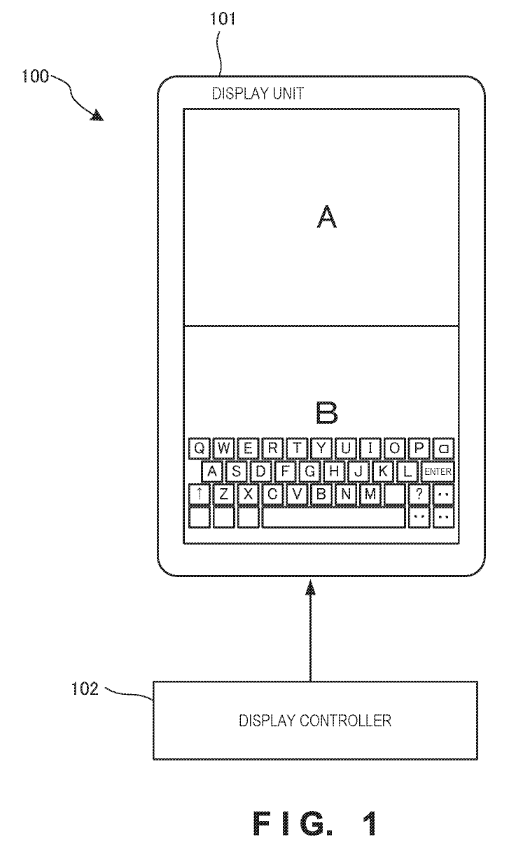

An information processing apparatus 100 according to the first embodiment of the present invention will be described with reference to FIG. 1. The information processing apparatus 100 is an apparatus for arranging the first display frame and a keyboard image so the keyboard image does not overlap the first display frame. As shown in FIG. 1, the information processing apparatus 100 includes a display unit 101 and a display controller 102. The display unit 101 arranges the first and second display frames in the vertical direction on a screen, and displays a keyboard image for an editing operation while displaying information in the first and second display frames. If the first display frame is a frame of interest, the display controller 102 arranges the first display frame and the keyboard image so they do not overlap each other.

According to this embodiment, it is possible to display the keyboard image so as not to make it difficult to see the screen of interest.

### Second Embodiment

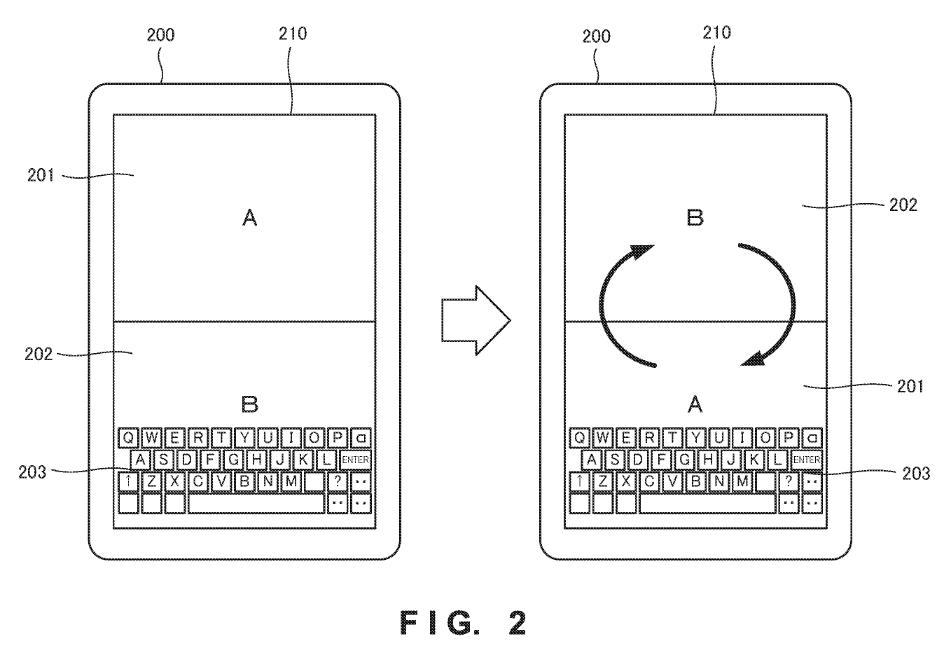

An information processing apparatus 200 according to the second embodiment of the present invention will be described next with reference to FIG. 2. FIG. 2 is a view for explaining an overview of the operation of the information processing apparatus 200 according to this embodiment. A screen A 201 is displayed on the upper side of a display screen 210 of the information processing apparatus 200 in the portrait orientation, and a screen B 202 is displayed on the lower side of the display screen 210. If a keyboard image 203 for an editing operation is displayed to input text and the like to the screen B 202 displayed on the lower side, the keyboard image 203 is overlaid and displayed on screen B, thereby hiding information and the like displayed on the screen B 202. That is, in this case, the presence of the keyboard image 203 makes it difficult to see the screen B 202 of interest of the user. To cope with this, the arrangement position of the screen A 201 and that of the screen B 202 are exchanged, and the screen B 202 is moved so the screen B 202 and the keyboard image 203 do not overlap each other, thereby arranging the screen B 202 at a position on the upper side of the display screen 210. That is, while the keyboard image 203 remains displayed at the predetermined position, the screen B 202 is moved to a position at which the keyboard image 203 is not displayed.

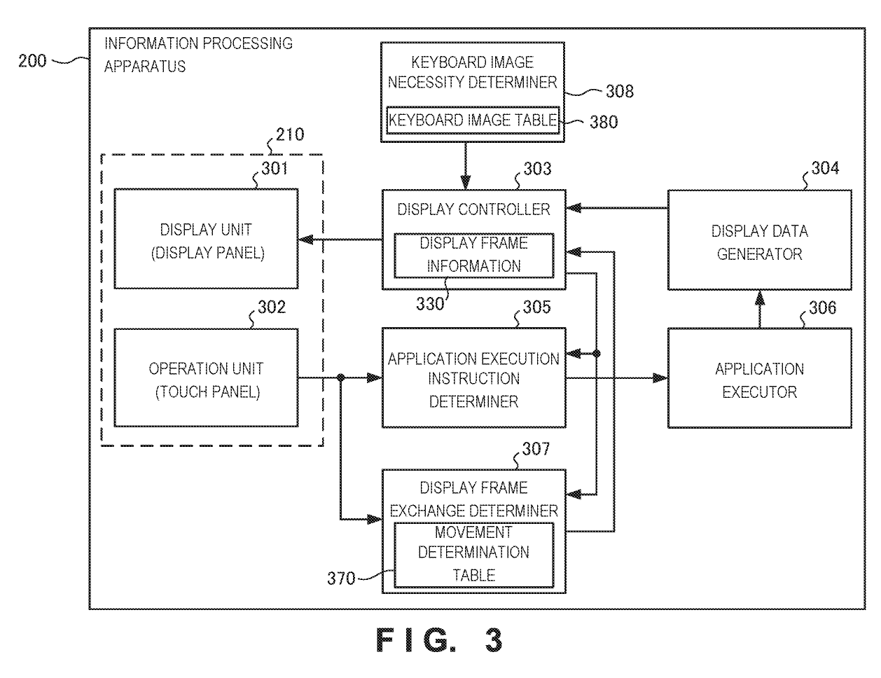

FIG. 3 is a block diagram showing the functional arrangement of the information processing apparatus 200 according to this embodiment. The information processing apparatus 200 includes the display screen 210 formed by a display unit 301 with a display panel and an operation unit 302 with a touch panel. The information processing apparatus 200 also includes a display controller 303, a display data generator 304, an application execution instruction determiner 305, and an application executor 306.

The application execution instruction determiner 305 determines an application execution instruction in the operation unit 302. In the case of the application execution instruction, the application executor 306 activates an application, and executes it. The display data generator 304 generates display data according to the executed application. The display controller 303 has display frame information 330, assigns, to a display frame, the display data generated by executing the application, and displays the display data on the display unit 301.

Furthermore, the information processing apparatus 200 includes a display frame exchange determiner 307 and a keyboard image necessity determiner 308. The display frame exchange determiner 307 has a movement determination table 370, determines whether the keyboard image is overlaid and displayed on a frame of interest, and sends a notification to the display controller 303. If an operation instruction has been issued for the application, the keyboard image necessity determiner 308 determines whether it is necessary to display the keyboard image 203. The keyboard image necessity determiner 308 determines the necessity of the keyboard image based on, for example, an operation of activating a document editing application, an operation of activating an moving image browsing application, an operation of tapping the search bar of an Internet browsing application, or the like. If it is necessary to display the keyboard image 203, the display controller 303 displays the keyboard image 203 at a predetermined position on the display unit 301.

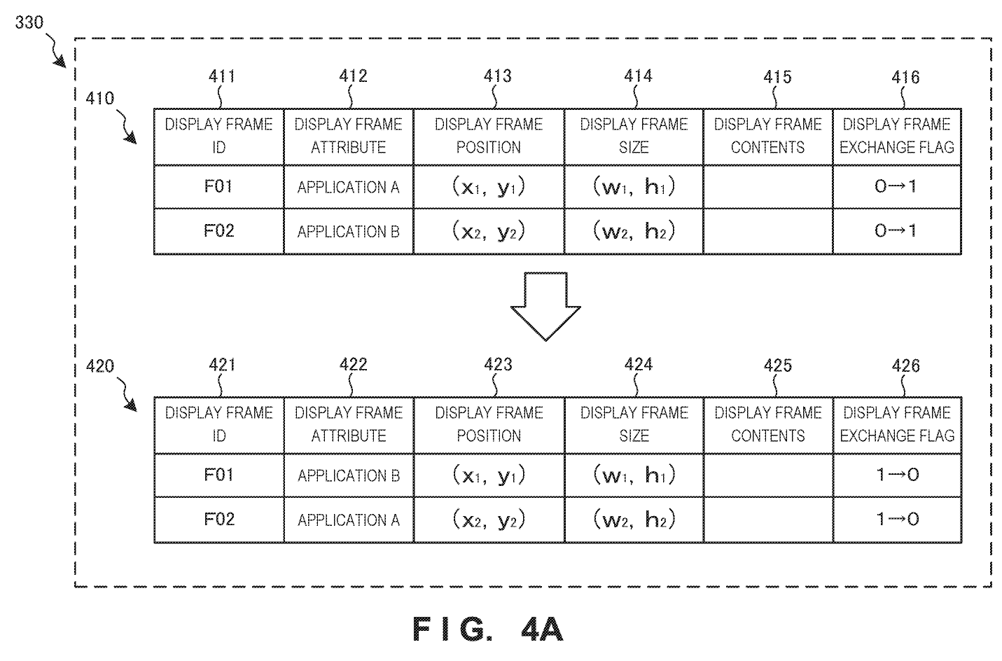

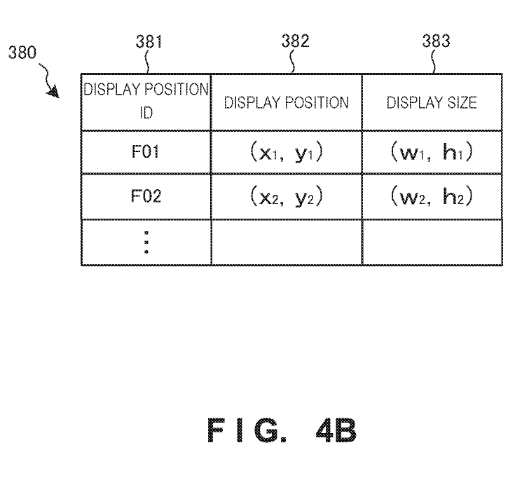

FIG. 4A is a view showing the structure of the display frame information 330. The display frame information 330 is used by the display controller 303 to arrange display information related to the application on the screen. Display frame information 410 is display frame information before the movement of display frames, and display frame information 420 is display frame information after the movement of the display frames. Display frame attributes 412 and 422, display frame positions 413 and 423, display frame sizes 414 and 424, display frame contents 415 and 425, and display frame exchange flags 416 and 426 are stored in association with display frame IDs 411 and 421. The display controller 303 moves the positions of the display frames based on the display frame information 330. If the display frame exchange flags are “1”, the display frames are moved. Alternatively, if the display frame exchange flags are “0”, no display frames are moved.

FIG. 4B is a table showing the structure of a keyboard image table 380. The keyboard image table 380 is used by the display controller 303 to arrange the keyboard image 203 on the screen. A display position 382 and a display size 383 of the keyboard image 203 are stored in association with a display position ID 381. The display position of the keyboard image 203 is determined based on the keyboard image table 380. With reference to the keyboard image table 380, the display controller 303 displays a frame of interest at a position where the keyboard image 203 is not displayed.

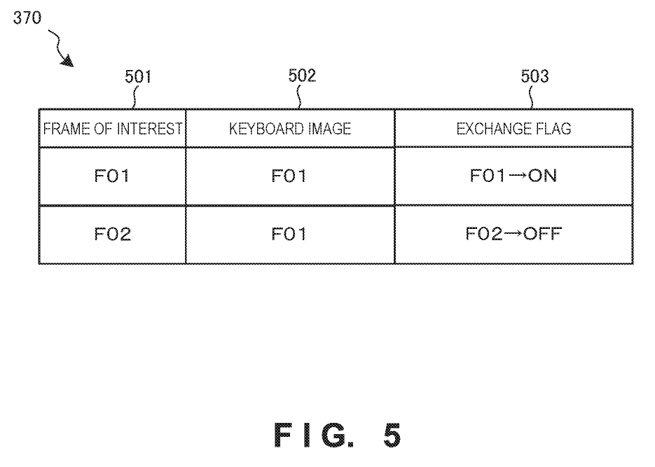

FIG. 5 is a table showing the structure of the movement determination table 370. The movement determination table 370 is used by the display frame exchange determiner 307 to determine whether it is necessary to exchange the display frames. The display frame exchange determiner 307 determines based on the display position of the frame of interest and that of the keyboard image whether the frame of interest and the keyboard image overlap each other. If the frame of interest and the keyboard image overlap each other, an exchange flag 503 of the frame of interest is turned on, thereby moving the frame of interest.

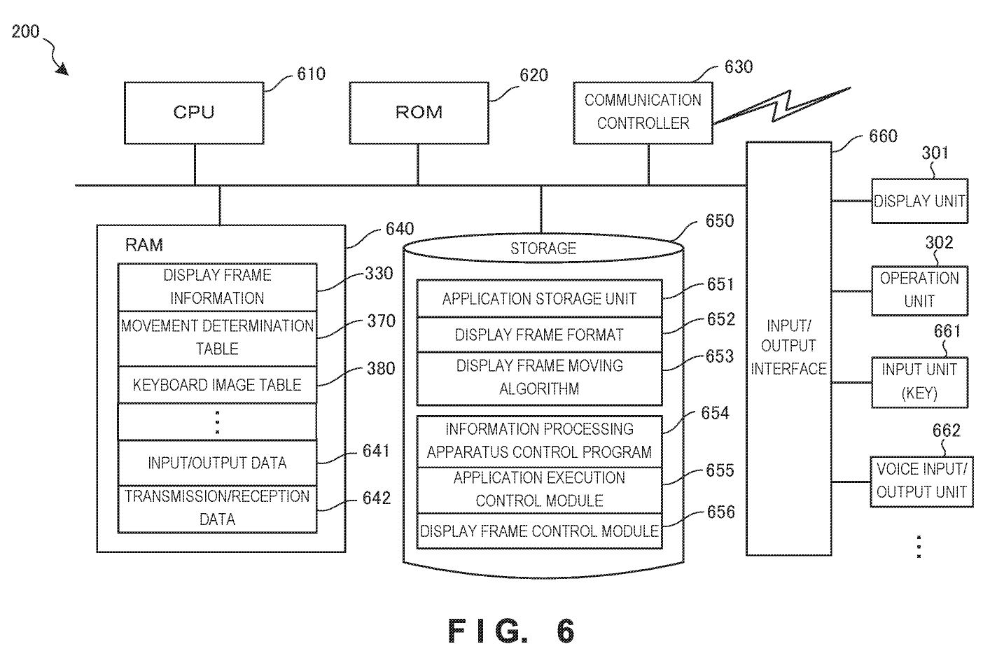

FIG. 6 is a block diagram showing the hardware arrangement of the information processing apparatus 200 according to this embodiment. The information processing apparatus 200 includes a CPU (Central Processing Unit) 610, a ROM (Read Only Memory) 620, and a RAM (Random Access Memory) 640. The information processing apparatus 200 also includes a communication controller 630, a storage 650, and an input/output interface 660.

The CPU 610 is an arithmetic processing processor, and implements the functional components of the information processing apparatus 200 by executing a program. Note that the number of CPUs 610 is not limited to one, and a plurality of CPUs or a GPU (Graphics Processing Unit) for image processing may be included. The ROM 620 is a read only memory, and stores programs such as firmware. The communication controller 630 communicates with another apparatus via a network. The communication controller 630 may include a CPU independent of the CPU 610, and writes or reads out transmission/reception data in or from the RAM 640. Furthermore, the input/output interface 660 may include a CPU independent of the CPU 610, and writes or reads out input/output data in or from the RAM 640.

The RAM 640 is a random access memory used as a temporary storage work area by the CPU 610. An area to store data necessary for implementation of the embodiment is allocated to the RAM 640. The RAM 640 stores, as the data, the display frame information 330, the movement determination table 370, the keyboard image table 380, input/output data 641, transmission/reception data 642, and the like. The display frame information 330 stores the definition of a display frame and the relation with an application. The movement determination table 370 is a table for determining whether it is necessary to exchange display frames. The input/output data 641 are data transferred to/from the display unit 301 and the operation unit 302 via the input/output interface 660. The transmission/reception data 642 are data transmitted/received via the communication controller 630.

The storage 650 is a storage device that stores a database and programs necessary for implementation of the embodiment. The storage 650 stores an application storage unit 651, a display frame format 652, and a display frame moving algorithm 653. The storage 650 also stores an information processing apparatus control program 654, an application execution control module 655, and a display frame control module 656.

An information processing apparatus control program 654 is a program for controlling the overall operation of the information processing apparatus 200. The application execution control module 655 is a module for executing applications stored in the application storage unit 651. The display frame control module 656 is a module for controlling the arrangement, on the display unit 301, of the display frames assigned with pieces of display information generated by executing the applications.

The input/output interface 660 serves as an interface for exchanging input/output data with an input/output device or the like. The input/output interface 660 is connected to the display unit 301, the operation unit 302, an input unit 661 with hardware keys, a voice input/output unit 662, and the like. Note that programs and data which are associated with the general-purpose functions of the information processing apparatus 200 and other feasible functions are not shown in the RAM 640 or the storage 650 of FIG. 6.

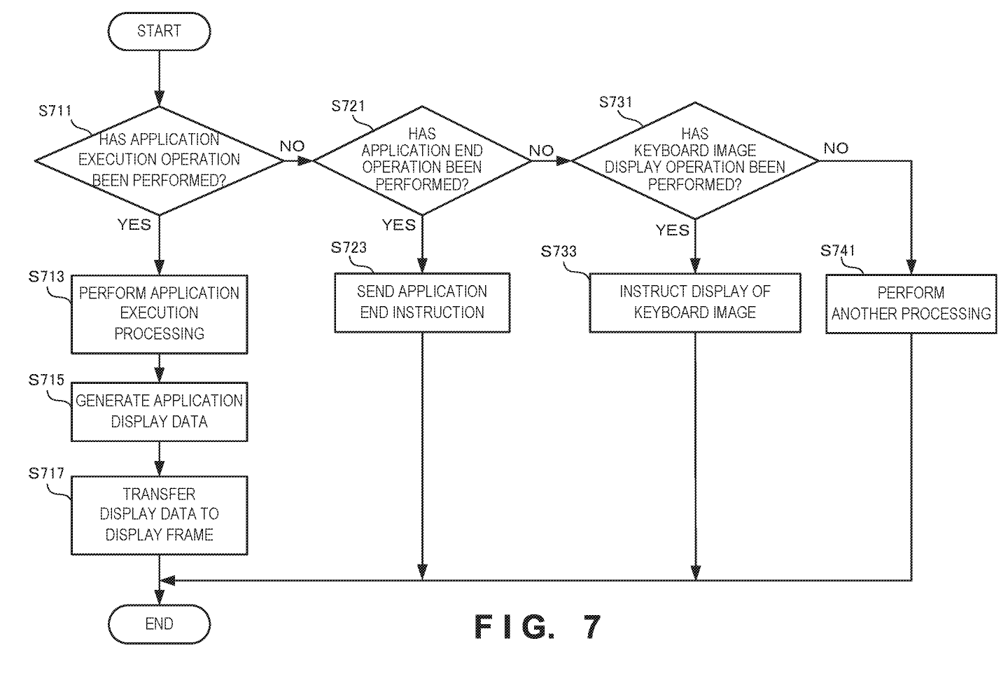

FIG. 7 is a flowchart illustrating the screen operation processing procedure of the information processing apparatus 200 according to this embodiment. This flowchart is executed by the CPU 610 using the RAM 640, thereby implementing the functional components of the information processing apparatus 200.

In step S711, the information processing apparatus 200 determines whether an application execution operation has been performed on a display screen. If an application execution operation has been performed, the information processing apparatus 200 executes an instructed application in step S713. In step S715, the information processing apparatus 200 generates display data related to execution of the application. In step S717, the information processing apparatus 200 transfers the generated display data to a display frame to display it in an assigned display frame.

If no application execution operation has been performed, the information processing apparatus 200 determines in step S721 whether an operation of ending the currently executed application has been performed. If the operation of ending the currently executed application has been performed, the information processing apparatus 200 ends the instructed application in step S723.

If neither an application execution operation nor an application end operation has been performed, the information processing apparatus 200 determines in step S731 whether a keyboard image display operation has been performed. If the keyboard image display operation has been performed, the information processing apparatus 200 instructs display of the keyboard image in step S733.

If none of an application execution operation, an application end operation, and a keyboard image display operation has been performed, the information processing apparatus 200 performs, in step S741, another processing instructed and operated.

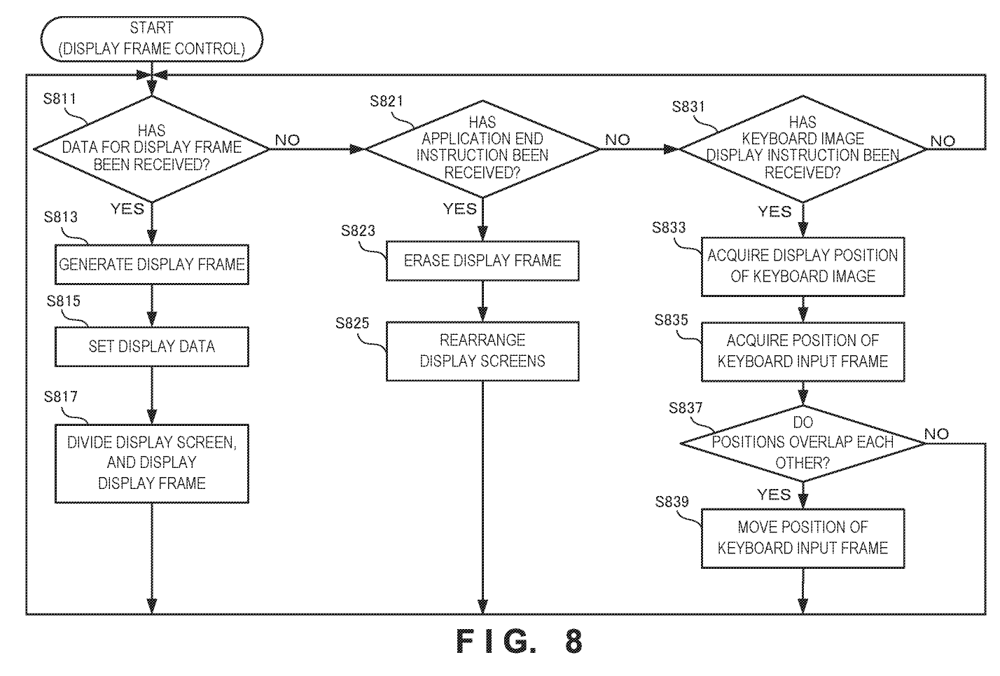

FIG. 8 is a flowchart illustrating the display frame moving processing procedure of the information processing apparatus 200 according to this embodiment. In step S811, the information processing apparatus 200 determines whether data for a display frame has been received by the processing in step S717 of FIG. 7. If data for a display frame has been received, the information processing apparatus 200 generates a display frame in step S813. Next, in step S815, the information processing apparatus 200 sets the received display data in the generated display frame. In step S817, the information processing apparatus 200 divides the display screen, and displays the display data of the display frame. Note that the procedure of dividing the display screen has been explained in steps S813 to S817 above. If divided screens are generated by a plurality of display frames, the display data is assigned to a display frame in correspondence with the application, and generation of a display frame in step S813 is unnecessary.

If no data for a display frame has been received, the information processing apparatus 200 determines in step S821 whether an application end instruction has been received by the processing in step S723 of FIG. 7. If the application end instruction has been received, the information processing apparatus 200 erases, in step S823, the display frame in which the display data is displayed. In step S825, the information processing apparatus 200 rearranges the display screens. Note that if the divided screens are preset, as described above, data are rearranged in the opened display frames, and erase of the display frame in step S823 is unnecessary.

If neither data for a display frame nor an application end instruction has been received, the information processing apparatus 200 determines in step S831 whether a keyboard image display instruction has been received by the processing in step S733 of FIG. 7. If the keyboard image display instruction has been received, the information processing apparatus 200 acquires, in step S833, a position at which the keyboard image is to be displayed. Next, in step S835, the information processing apparatus 200 acquires the position of a keyboard input frame as an input target by the keyboard. In step S837, the information processing apparatus 200 determines whether the display position of the keyboard image acquired by the processing in step S833 overlaps the position of the keyboard input frame acquired by the processing in step S835. If the display position of the keyboard image overlaps the position of the keyboard input frame, the information processing apparatus 200 moves the position of the keyboard input frame in step S839. If the display position of the keyboard image does not overlap the position of the keyboard input frame, the information processing apparatus 200 displays the keyboard image and the keyboard input frame intact.

According to this embodiment, it is possible to display the keyboard image so as not to make it difficult to see the screen of interest by moving the display frame while displaying the keyboard image at the predetermined position.

### Third Embodiment

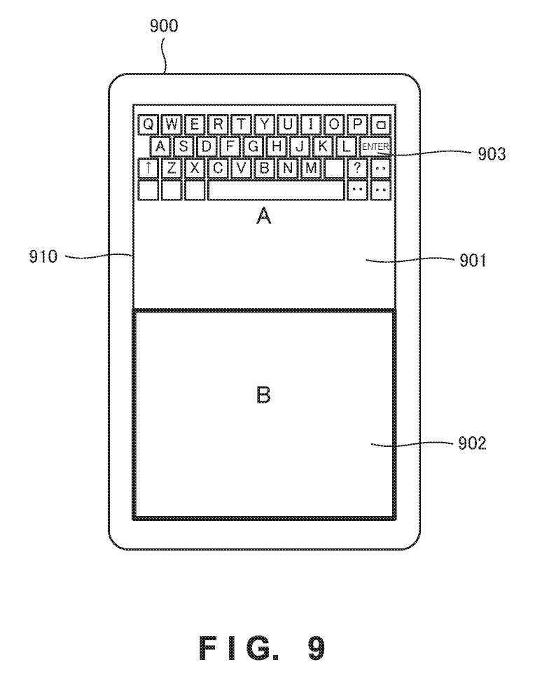

An information processing apparatus 900 according to the third embodiment of the present invention will be described next with reference to FIGS. 9 to 11. FIG. 9 is a view for explaining an overview of the operation of the information processing apparatus 900 according to this embodiment. The information processing apparatus 900 according to this embodiment is different from that according to the second embodiment in that a keyboard image is displayed at a position not overlapping a frame of interest without moving the frame of interest. The remaining components and operations are the same as those in the second embodiment. Hence, the same reference numerals denote the same components and operations, and a detailed description thereof will be omitted.

A screen A 901 is displayed on the upper side of a display screen 910 of the information processing apparatus 900 in the portrait orientation, and a screen B 902 is displayed on the lower side of the display screen 910. When, for example, the screen B 902 is a frame of interest, if a keyboard image 903 is displayed on the lower side of the display screen 910, the screen B 902 of interest is hidden by the keyboard image. For this reason, the keyboard image 903 is displayed on the upper side of the display screen 910 so the keyboard image 903 is not overlaid and displayed on the screen B 902. That is, the keyboard image 903 is displayed in a region other than that where the screen B 902 of interest is displayed. This makes it possible to display the keyboard image 903 at a position not overlapping the screen B 902 without changing the display position of the screen B 902.

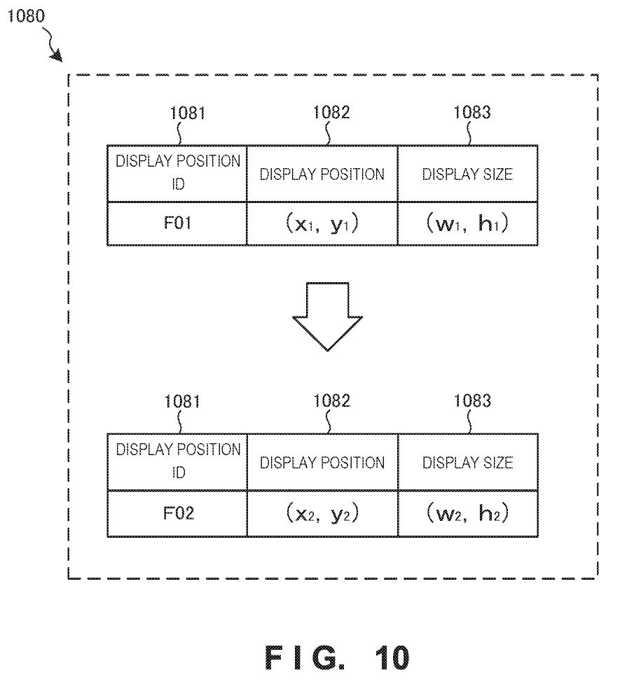

FIG. 10 is a table showing the structure of a keyboard image table 1080. The keyboard image table 1080 is used by a display controller 303 to arrange the keyboard image 903 on the display screen 910. A display position 1082 and a display size 1083 of the keyboard image 903 are stored in association with a display position ID 1081. The display position of the keyboard image 903 is determined based on the keyboard image table 380. If the display positions of the image B 902 of interest and the keyboard image 903 are set for the display position ID 1081 of F01, the display position of the keyboard image 903 is displayed for the display position ID 1081 of F02 for which no image B 902 is displayed.

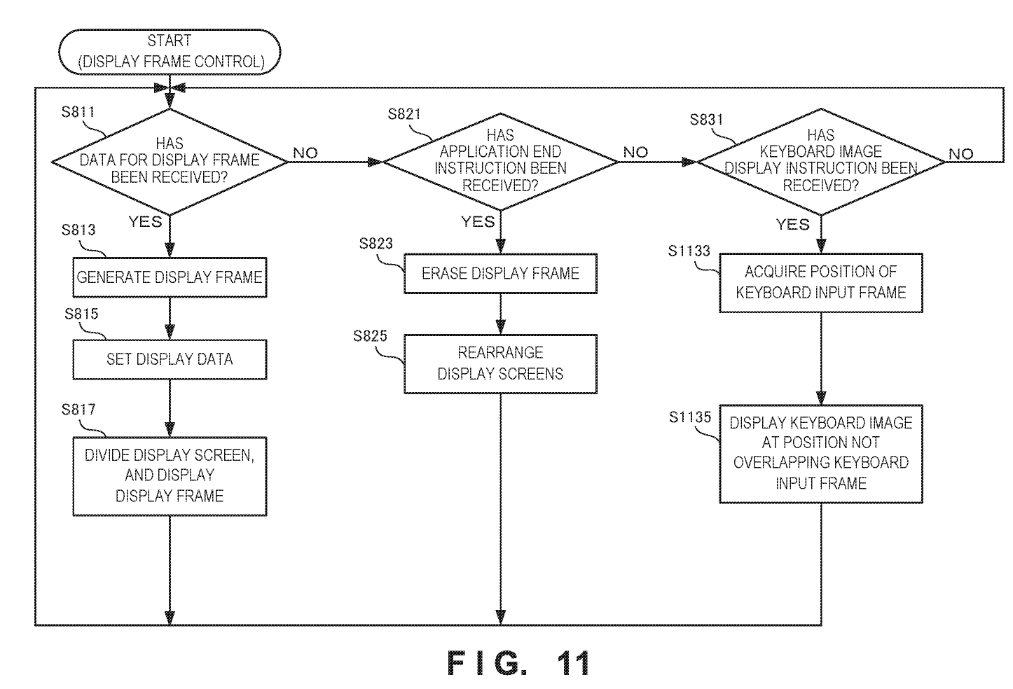

FIG. 11 is a flowchart illustrating the keyboard image display processing procedure of the information processing apparatus 900 according to this embodiment. Note that the same step numbers as those in FIG. 8 denote the same steps, and a description thereof will be omitted. If neither data for a display frame nor an application end instruction has been received, the information processing apparatus 900 acquires the position of a keyboard input frame in step S1133. Next, in step S1135, the information processing apparatus 900 displays the keyboard image 903 at a position not overlapping the keyboard input frame.

According to this embodiment, since the keyboard image is displayed at a position not overlapping the display frame without changing the position of the display frame, it is possible to display the keyboard image so as not to make it difficult to see the screen of interest.

### Fourth Embodiment

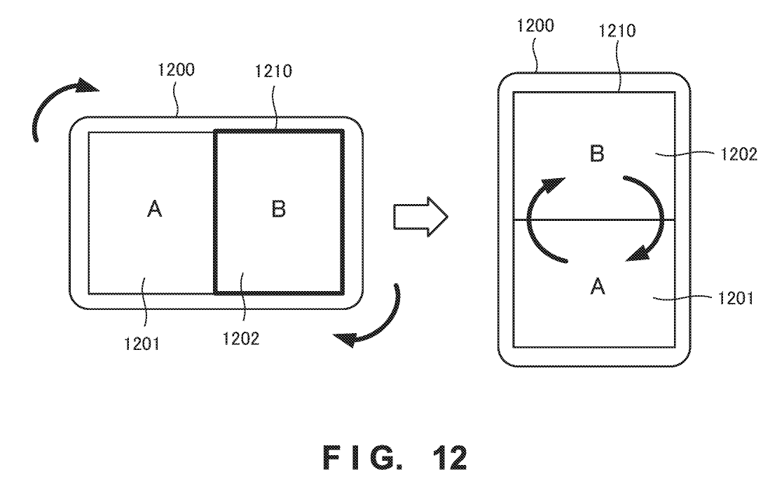

An information processing apparatus 1200 according to the fourth embodiment of the present invention will be described next with reference to FIGS. 12 to 14. FIG. 12 is a view for explaining an overview of the operation of the information processing apparatus 1200 according to this embodiment. The information processing apparatus 1200 according to this embodiment is different from that according to the second embodiment in that a currently operated display frame, an active display frame, or the like is displayed on the upper side of a display screen. The remaining components and operations are the same as those in the second embodiment. Hence, the same reference numerals denote the same components and operations, and a detailed description thereof will be omitted.

In the information processing apparatus 1200 in the landscape orientation, a screen A 1201 is displayed on the left side of a display screen 1210 and a screen B 1202 is displayed on the right side of the display screen 1210. If the screen B 1202 displayed on the right side is a screen of interest, the information processing apparatus 1200 is rotated in the clockwise direction, and set in the portrait orientation. If the information processing apparatus 1200 is in the portrait orientation, the screen A 1201 is displayed on the upper side of the display screen 1210, and the screen B 1202 of interest is displayed on the lower side. The keyboard image is set to be displayed on the lower side of the display screen 1210. Then, if the keyboard image is displayed while the screen B 1202 is displayed on the lower side, the keyboard image is overlaid and displayed on the screen B 1202, thereby hiding the screen B 1202. In this case, since the display position of the keyboard image is known, if the information processing apparatus 1200 is set in the portrait orientation, the image B 1202 of interest is displayed in advance on the upper side of the display screen 1210. This prevents the screen B 1202 and the keyboard image 1203 from overlapping each other.

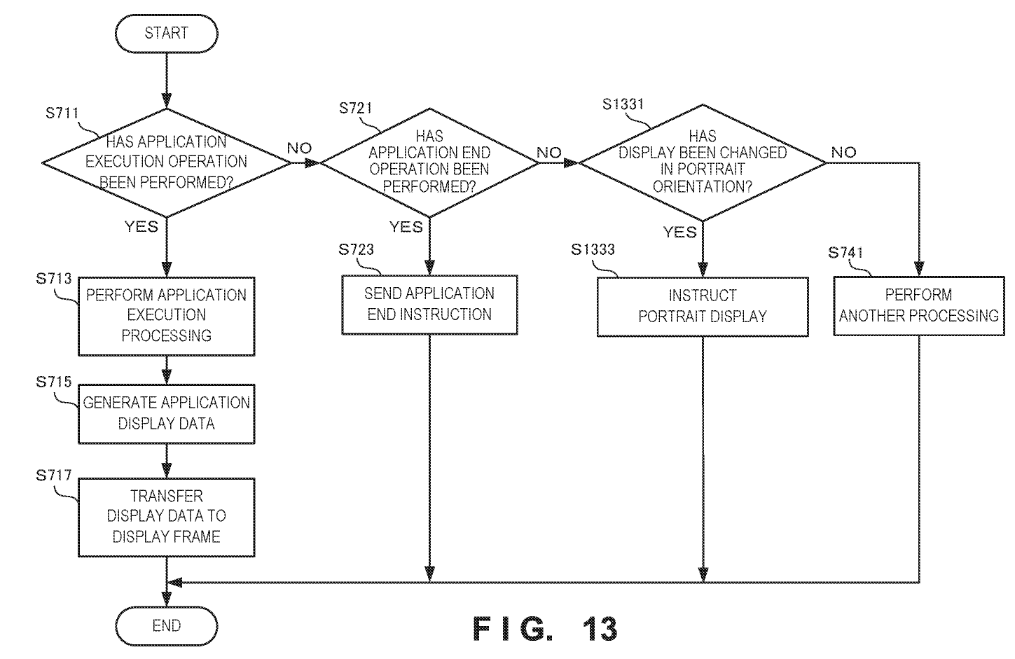

FIG. 13 is a flowchart illustrating the screen operation processing procedure of the information processing apparatus 1200 according to this embodiment. Note that the same step numbers as those in FIG. 7 denote the same steps, and a description thereof will be omitted. If neither an application execution operation nor an application end operation has been performed, the information processing apparatus 1200 determines in step S1331 whether a display has been changed in the portrait orientation. If the display has been changed in the portrait orientation, the information processing apparatus 1200 instructs portrait display in step S1333.

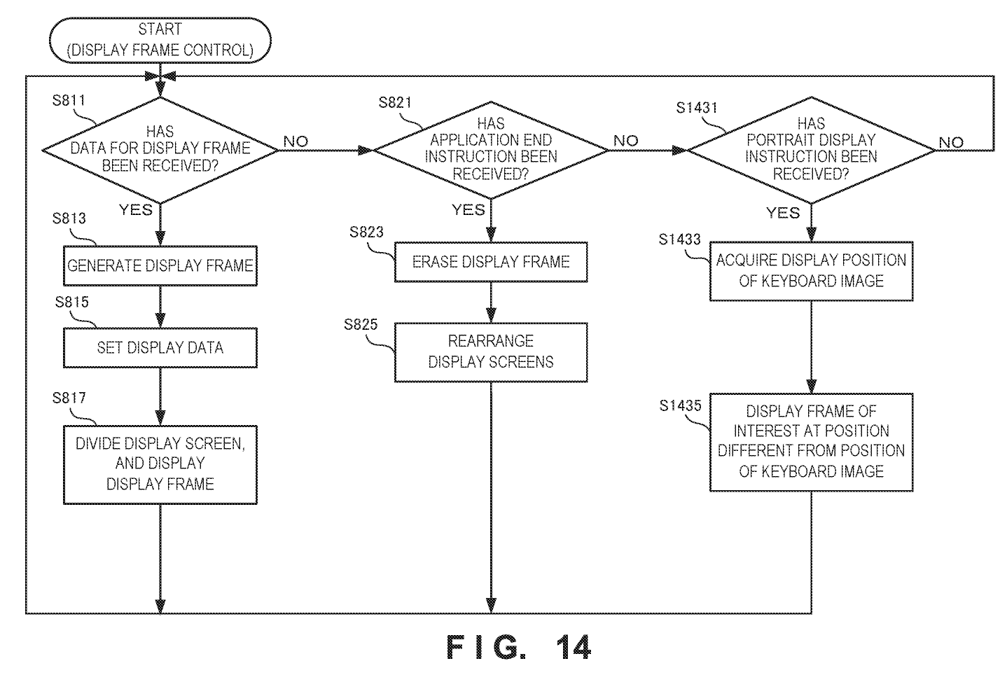

FIG. 14 is a flowchart illustrating the display frame moving processing procedure of the information processing apparatus 1200 according to this embodiment. Note that the same step numbers as those in FIG. 8 denote the same steps, and a description thereof will be omitted. If neither data for a display frame nor an application end instruction has been received, the information processing apparatus 1200 determines in step S1431 whether a portrait display instruction has been received by the processing in step S1333 of FIG. 13. If the portrait display instruction has been received, the information processing apparatus 1200 acquires the display position of the keyboard image in step S1433. Next, the information processing apparatus 1200 displays, in advance, in step S1435, the frame of interest at a position different from that where the keyboard image is displayed.

According to this embodiment, since the frame of interest is displayed in advance at a position different from that where the keyboard image is displayed, it is possible to display the keyboard image so as not to make it difficult to see the screen of interest.

### Fifth Embodiment

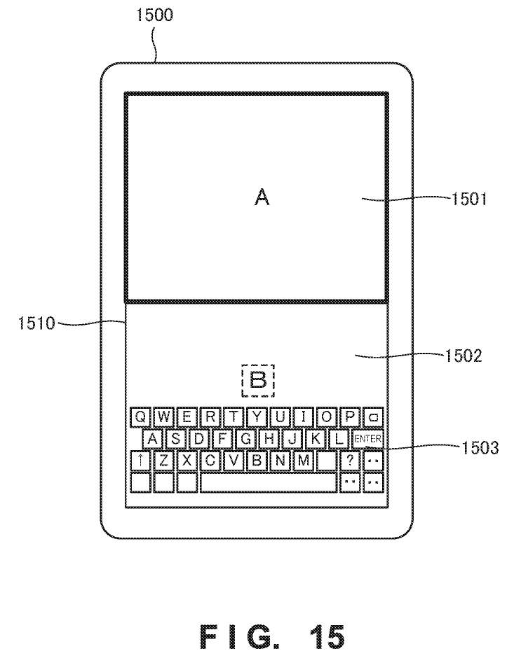

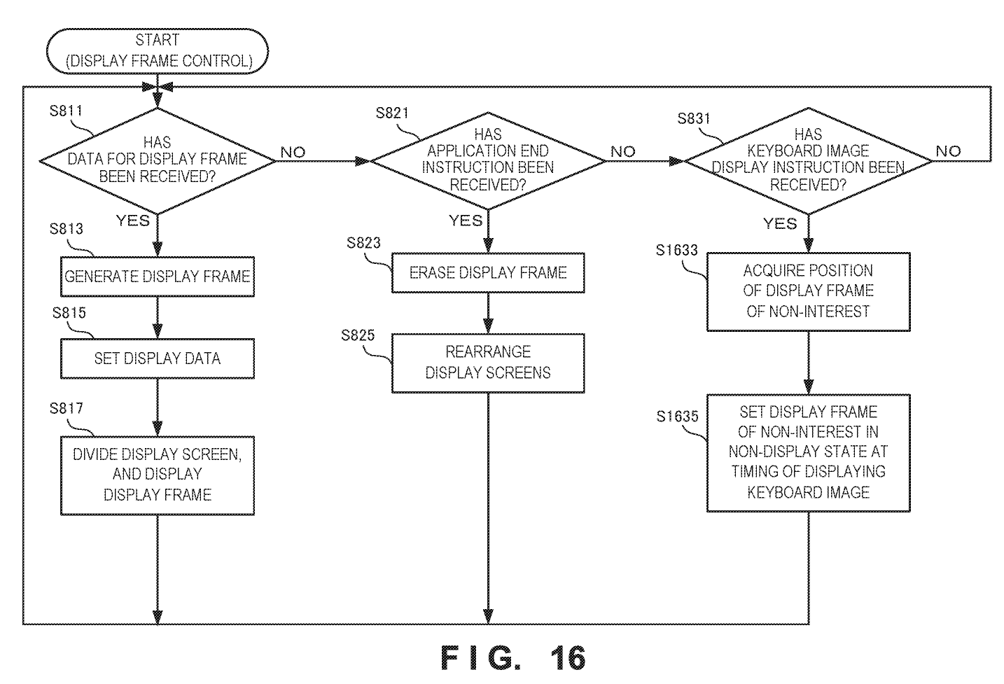

An information processing apparatus 1500 according to the fifth embodiment of the present invention will be described next with reference to FIGS. 15 and 16. FIG. 15 is a view for explaining an overview of the operation of the information processing apparatus 1500 according to this embodiment. The information processing apparatus 1500 according to this embodiment is different from that according to the second embodiment in that a display frame of non-interest is set in a non-display state at the timing of displaying a keyboard image. The remaining components and operations are the same as those in the second embodiment. Hence, the same reference numerals denote the same components and operations, and a detailed description thereof will be omitted.

A screen A 1501 as a frame of interest is displayed on the upper side of a display screen 1510 of the information processing apparatus 1500, and a keyboard image 1503 is displayed at a position not overlapping the screen A 1501. Screen B is displayed on a screen 1502 on the lower side of the display screen 1510. However, screen B is a display frame of non-interest, and is thus set in the non-display state at the timing of displaying the keyboard image 1503.

Note that this embodiment has explained the example in which the display frame of non-interest is set in the non-display state. This embodiment is not limited to this. For example, if the screen A 1501 of interest is a display frame on which a moving image or an image is displayed, the display frame may be displayed on the upper side and the remaining display frames may be set in the non-display state. That is, in this case, display frames other than the screen A 1501 correspond to display frames of non-interest. This embodiment is also applicable to a case in which the frame of interest is a display frame whose display is changed by an operation for the keyboard image, and a case in which the frame of interest is a display frame operated before displaying the keyboard image.

FIG. 16 is a flowchart illustrating the display frame moving processing procedure of the information processing apparatus 1500 according to this embodiment. Note that the same step numbers as those in FIG. 8 denote the same steps, and a description thereof will be omitted. If neither data for a display frame nor an application end instruction has been received, the information processing apparatus 1500 acquires the position of a display frame of non-interest in step S1633. In step S1635, the information processing apparatus 1500 sets the display frame of non-interest in the non-display state at the timing of displaying the keyboard image 1503.

According to this embodiment, since the frame of interest and the keyboard image are displayed and the display frame of non-interest is set in the non-display state, it is possible to display the keyboard image so as not to make it difficult to see the screen of interest.

### Sixth Embodiment

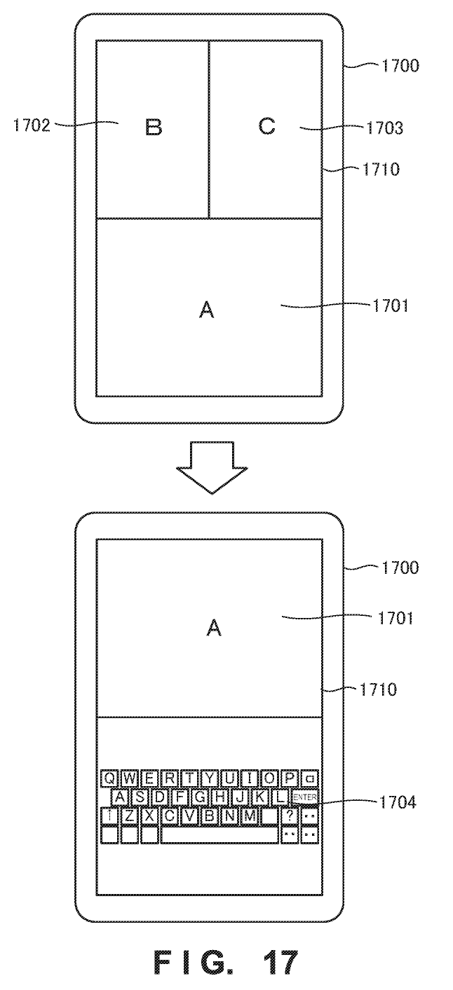

An information processing apparatus 1700 according to the sixth embodiment of the present invention will be described next with reference to FIG. 17. FIG. 17 is a view for explaining an overview of the operation of the information processing apparatus 1700 according to this embodiment. The information processing apparatus 1700 according to this embodiment is different from that according to the second embodiment in that three screens are displayed. The remaining components and operations are the same as those in the second embodiment. Hence, the same reference numerals denote the same components and operations, and a detailed description thereof will be omitted.

A screen A 1701 as a frame of interest is displayed on the lower side of a display screen 1710 of the information processing apparatus 1700. In addition, a screen B 1702 is displayed on the upper left side of the display screen 1710, and a screen C 1703 is displayed on the upper right side of the display screen 1710. The screen B 1702 and the screen C 1703 are frames of non-interest (the upper view). If an input operation or the like to the screen A 1701 as the frame of interest is performed using a keyboard image 1704, the screen A 1701 is displayed on the upper side of the display screen 1710, and the keyboard image 1704 is displayed on the lower side of the display screen 1710 (the lower view). In this case, the screen B 1702 and the screen C 1703 as display frames of non-interest may be set in the non-display state, or the screen B 1702 and the screen C 1703 may be displayed on the lower side of the display screen 1710 and the keyboard image 1704 may be displayed to be overlaid on the two screens.

According to this embodiment, even if three screens are displayed, it is possible to display the keyboard image so as not to make it difficult to see the screen of interest.

### Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-188302 filed on Sep. 16, 2014, which is hereby incorporated by reference herein in its entirety.

1. An information processing apparatus comprising:
a display unit that arranges a first display frame and a second display frame in a vertical direction on a screen, and displays a keyboard image for an editing operation while displaying information in the first display frame and the second display frame; and
a display controller that arranges, if the first display frame is a frame of interest, the first display frame and the keyboard image so the first display frame and the keyboard image do not overlap each other.

2. The information processing apparatus according to claim 1, wherein said display controller displays the keyboard image at a predetermined position, and moves the first display frame to a position not overlapping the keyboard image.

3. The information processing apparatus according to claim 1, wherein said display controller displays the keyboard image at a position not overlapping the first display frame without changing a position of the first display frame.

4. The information processing apparatus according to claim 1, wherein said display controller sets the second display frame in a non-display state at a timing of displaying the keyboard image.

5. The information processing apparatus according to claim 1, wherein the frame of interest is a display frame whose display is changed by an operation for the keyboard image.

6. The information processing apparatus according to claim 1, wherein the frame of interest is a display frame on which one of a moving image and an image is displayed.

7. The information processing apparatus according to claim 1, wherein the frame of interest is a display frame operated before displaying the keyboard image.

8. An information processing method comprising:
arranging a first display frame and a second display frame in a vertical direction on a screen, and displaying a keyboard image for an editing operation while displaying information in the first display frame and the second display frame; and
arranging, if the first display frame is a frame of interest, the first display frame and the keyboard image so the first display frame and the keyboard image do not overlap each other.

9. A non-transitory computer readable medium storing an information processing program for causing a computer to execute a method, comprising:
arranging a first display frame and a second display frame in a vertical direction on a screen, and displaying a keyboard image for an editing operation while displaying information in the first display frame and the second display frame; and
arranging, if the first display frame is a frame of interest, the first display frame and the keyboard image so the first display frame and the keyboard image do not overlap each other.

10. The information processing apparatus according to claim 2, wherein said display controller sets the second display frame in a non-display state at a timing of displaying the keyboard image.

11. The information processing apparatus according to claim 3, wherein said display controller sets the second display frame in a non-display state at a timing of displaying the keyboard image.

12. The information processing apparatus according to claim 2, wherein the frame of interest is a display frame whose display is changed by an operation for the keyboard image.

13. The information processing apparatus according to claim 2, wherein the frame of interest is a display frame on which one of a moving image and an image is displayed.

14. The information processing apparatus according to claim 2, wherein the frame of interest is a display frame operated before displaying the keyboard image.

15. The information processing apparatus according to claim 3, wherein the frame of interest is a display frame whose display is changed by an operation for the keyboard image.

16. The information processing apparatus according to claim 3, wherein the frame of interest is a display frame on which one of a moving image and an image is displayed.

17. The information processing apparatus according to claim 3, wherein the frame of interest is a display frame operated before displaying the keyboard image.
